(19) United States
(12) Patent Application Publication
(10) Pub. No.: US 2016/0180126 A1
(43) Pub. Date: Jun. 23, 2016

(54) Method and System for Assets Management Using Integrated Unmanned Aerial Vehicle and Radio Frequency Identification Reader

(71) Applicant: Kashif Saleem, Perth (AU)

(72) Inventor: Kashif Saleem, Perth (AU)

(21) Appl. No.: 14/875,653

(22) Filed: Oct. 5, 2015

Related U.S. Application Data
(60) Provisional application No. 62/059,971, filed on Oct. 5, 2014.

(51) Int. Cl. G06K 7/10; H04N 7/18

(52) U.S. Cl. CPC G06K 7/10376; H04N 7/185

(57) ABSTRACT

The invention is a system for managing assets, and includes; at least one RFID tag coupled to one or more assets, an unmanned aerial vehicle with an RFID reader, a ground management subsystem with a host computing unit and an enterprise resource planning module, a network subsystem, a portable computing and communications device for facilitating transmission, reception, processing and storage of data, and one or more sensors for capturing images and data.

### FIELD OF THE INVENTION

The present invention generally relates to assets management, and more particularly, to a method and system for assets management using an integrated Unmanned Aerial Vehicle (UAV) and Radio Frequency Identification (RFID) reader.

### BACKGROUND OF THE INVENTION

Asset Management on the field or outdoors often requires the control of material, equipment, assets etc. in often large and open spaces. An initial inspection upon first arrival of the items of materials or assets on site may be required in order to check for defects, etc. Subsequent to initial inspection, knowledge of current status, for instance, at least one of arrival, consumption, presence, absence and physical (or material) condition, quality and the location, to be precise accurate position, of the items of materials or assets, and a combination thereof is utmost important.

In some project implementation scenarios involving deployment of at least one of active and passive RFID tags, one or more significant objectives are efficiency enhancement and cost reduction. However, with the deployment of passive RFID tags one problem is reduced—read range owing to the fact that the passive RFID tags lack a power source. On the other hand, active tags have a power source, but are relatively expensive and have a limited life time operation since the active tags self-powered but hybrid tags which have both active and passive components can also be utilised.

Another problem with design, deployment and implementation of conventional RFID-based systems for materials or assets management is management of trade-off between one or more at least one of required and desired levels of one or more qualitative and quantitative parameters, such as productivity, economic feasibility, multi-functionality (or multipurpose), multitasking, applicability in rugged and long-haul use-case scenarios. For instance, conventional RFID-based systems at least one of unmanned and manned portable fail to provide the option of increasing productivity and reducing costs with multiple tags readability across wide areas.

By combing an Active RFID reader with a drone, one is enabled to record a wide variety of information from the tag (there are 1000's of Active RFID tags, some of which have microprocessors/sensors), data that can be transmitted over long distances (some tags have a read range of more than 100 m).

One of the main objectives of the technology is to build on the multi tag collection ability of Active RFID technology, where multiple tags can be read and data collected and transmitted simultaneously using a UAV which can cover large areas, some of which could be difficult to reach from the ground. Using the technology proposed, we will be able to not only update the location of the asset that the tag has been assigned to, but will be able to capture vital data as well assign data to the tag, so that it can be read on the ground at a later date if required through data writing capabilities that Active Tags have.

### SUMMARY OF THE INVENTION

Embodiments of the present invention are systems for managing assets. The system comprises one or more RFID tags coupled to one or more assets and an Unmanned Aerial Vehicle (UAV), a ground management subsystem including a host computing unit with an Enterprise Resource Planning module, and a network subsystem. The UAV includes a Radio Frequency Identification (RFID) reader for at least one of reading, writing, and a combination thereof, RFID signals from, and to, the RFID tags, a portable computing and communications device for facilitating transmission, reception, processing and storage of data, and one or more sensors for capturing images and data.

### BRIEF DESCRIPTIONS OF THE DRAWINGS

FIG. 1 depicts a block diagram of the system for assets (or materials) management using an integrated Unmanned Aerial Vehicle (UAV) and a Radio Frequency Identification (RFID) reader, in accordance with the present invention;

FIG. 2 depicts a block diagram of a quadcopter designed and implemented in accordance with the present invention;

FIG. 3A depicts a schematic representation of reaction torques on each motor of the quadcopter of FIG. 2;

FIG. 3B depicts the autonomous adjustment of the altitude of flying by the quadcopter of FIG. 2 via application of equal thrust to two pairs of rotors;

FIG. 3C depicts the autonomous adjustment of the yaw by the quadcopter of FIG. 2 via application of relatively higher thrust to the first pair of rotors rotating in clockwise direction;

FIG. 3D depicts the autonomous adjustment of the pitch or roll via application of relatively higher thrust to the one rotor and lower to the another positioned diametrically opposite thereto of the quadcopter of FIG. 2;

FIG. 4 depicts a computer system utilized in various embodiments of the present invention;

FIG. 5A depicts a block diagram of the UAV (or quadcopter), and components thereof, according to one or more embodiments;

FIG. 5B depicts a block diagram of the mission sensors subunit 512 of FIG. 5A;

FIG. 5C depicts a block diagram of the navigation sensors subunit 514 of FIG. 5A;

FIG. 5D depicts a block diagram of the stabilization sensors subunit 516 of FIG. 5A;

FIG. 5E depicts a block diagram of the power unit 504 of FIG. 5A;

FIG. 5F depicts a block diagram of the airframe 506 of FIG. 5A;

FIG. 5G depicts a block diagram of the software unit 510 of FIG. 5A;

FIG. 5H depicts a block diagram of the AI sub-module 622 of FIG. 5G;

FIG. 5I depicts a block diagram of the autopilot sub-module 678 of FIG. 5G; and

FIG. 5J depicts a block diagram of the telemetry sub-module 680 of FIG. 5G.

### DETAILED DESCRIPTION OF THE INVENTION

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

While the method and system is described herein by way of example for several embodiments and illustrative drawings, those skilled in the art will recognize that the method and system for assets management using integrated Unmanned Aerial Vehicle (UAV) and Radio Frequency Identification (RFID) reader, is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and system for assets management using integrated Unmanned Aerial Vehicle (UAV) and Radio Frequency Identification (RFID) reader defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

In some embodiments, a system for assets management using an integrated Unmanned Aerial Vehicle (UAV) and Radio Frequency Identification (RFID) reader, and a method therefor are disclosed, in accordance with the principles of the present invention. For example, and in no way limiting the scope of the invention, the assets may be at least one of fixed assets (or Property, Plant, and Equipment (PPE)) and tangible assets. Specifically, the fixed assets may be purchased for continued and long-term use in earning profit in a business. More specifically, the fixed assets includes, but is not limited to, land, buildings, machinery, furniture, tools, IT equipment, for instance laptops, and certain wasting resources, for instance timberland and minerals. Likewise, the tangible assets may be physical substances, for instance buildings, real estate, vehicles, inventories, equipment, and precious metals.

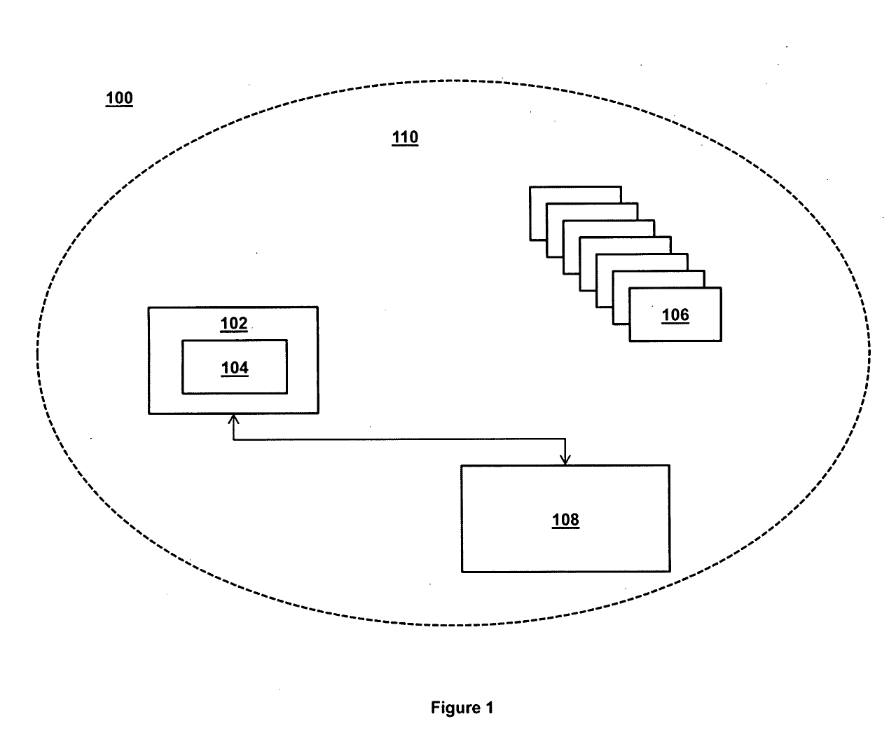

FIG. 1 depicts a block diagram of the system for assets (or materials) management using the integrated Unmanned Aerial Vehicle (UAV) and Radio Frequency Identification (RFID) reader, according to one or more embodiments.

In some embodiments, the system may facilitate management of assets (or materials) using the integrated Unmanned Aerial Vehicle (UAV) and Radio Frequency Identification (RFID) reader. Specifically, the system may facilitate at least one of detecting or identifying the assets, capturing images or information in connection with the assets, analyzing the captured images or information, tracking the captured assets based on the captured images or information, profiling the assets, categorizing the assets based on the profiles, controlling, maintaining and assessing the quality of the assets.

The system 100 may comprise the UAV 102, the RFID reader 104, one or more RFID tags 106, a ground management subsystem 108 and a network subsystem 110.

In general, the UAVs may be categorized into one of six functional categories. For example, 1) target and decoy providing ground and aerial gunnery a target that simulates an enemy aircraft or missile; 2) reconnaissance providing battlefield intelligence and sensory data; 3) combat providing attack capability for high-risk missions, for instance Unmanned Combat Air Vehicle (UCAV); 4) logistics providing for cargo and logistics operations; and 5) research and development providing for further development of UAV technologies to be integrated into field deployed UAV aircrafts.

Further, in general, the UAVs may be categorized in terms of at least one of range and altitude. For instance, 1) hand-held with an altitude of approximately 2,000 ft (600 m) altitude and a range of approximately 2 km; 2) close with an altitude of approximately 5,000 ft (1,500 m) and a range of approximately 10 km range; 3) NATO type with an altitude of approximately 10,000 ft (3,000 m) altitude and a range of approximately 50 km range; 4) tactical with an altitude of approximately 18,000 ft (5,500 m) altitude and a range of approximately 160 km range; 5) Medium Altitude, Long Endurance (MALE) with an altitude of approximately 30,000 ft (9,000 m) and a range of approximately 200 km; 6) High Altitude, Long Endurance (HALE) with an altitude of approximately 30,000 ft (9,100 m) and an indefinite range; 7) High-Speed, Supersonic (HYPERSONIC) (Mach 1-5) or HYPERSONIC (Mach 5+) with an altitude of approximately 50,000 ft (15,200 m) or suborbital altitude and a range of approximately 200 km; 8) ORBITAL low-earth orbit (Mach 25+); 9) CIS Lunar Earth-Moon transfer; and 10) Computer Assisted Carrier Guidance System (CACGS) for UAVs.

In some embodiments, the UAV may be designed and implemented in accordance with the principles of the present invention. For example, and in no way limiting the scope of the invention, the UAV 102 may be at least one of a miniature UAV, Small UAV (SUAV), Micro Air Vehicle (MAV), drone, Remotely Piloted Aircraft (RPA), Radio-Controlled (model) aircraft (RC aircraft or RC plane) and a quadcopter. Specifically, the UAV 102 may be capable of flying autonomously without a human pilot aboard. More specifically, the autonomous flight of the UAV 102 may be controlled at least one of fully autonomously via onboard computers, and partially manually via a remote control of, or with, the human pilot on at least one of the ground and in another vehicle. Still more specifically, the launch and recovery method of the UAV 102 may be performed at least one of fully automatically via usage of the onboard computers, and partially manually via the human pilot equipped with the remote control confined to at least one of the ground and in another vehicle.

In some embodiments involving commercial aerial surveillance, deployment of the UAV 102 may facilitate aerial surveillance of large areas with high economic feasibility. For example, and in no way limiting the scope of the invention, the surveillance applications may include, but are not limited to, livestock monitoring, wildfire mapping, pipeline security, home security, road patrol, anti-piracy, imaging overlays, environmental studies, construction, people/event tracking.

In some embodiments involving remote sensing, deployment of the UAV 102 may facilitate realization and implementation of remote sensing functions via deployment of one or more sensors including, but not limited to, electromagnetic spectrum sensors, gamma ray sensors, biological sensors, and chemical sensors (not shown and numbered). For example, and in no way limiting the scope of the invention, the electromagnetic spectrum sensors of the UAV 102 may typically include, but are not limited to, visual spectrum, infrared, near infrared cameras as well as radar systems (not shown and numbered). In some embodiments, the UAV 102 may facilitate realization and implementation of remote sensing functions via deployment of one or more wave detectors including, but not limited to, electromagnetic wave detectors, such as microwave and ultraviolet spectrum sensors (not shown and numbered). Specifically, the biological sensors are sensors capable of detecting the airborne presence of various microorganisms and other biological factors. Likewise, chemical sensors use laser spectroscopy to analyze the concentrations of each element in the air.

In some embodiments, deployment of the UAV 102 may facilitate commercial and motion picture filmmaking.

In some embodiments, deployment of the UAV 102 may facilitate sports photography and cinematography. Specifically, the UAV 102 may facilitate various types of close-up in sports via getting closer to the athletes since the UAV 102 is more flexible than cable-suspended camera systems.

In some embodiments involving oil, gas and mineral exploration and production, deployment of the UAV 102 may facilitate performance of geophysical surveys. For instance, the UAV 102 may facilitate geomagnetic surveys, wherein the processed measurements of the Earth's differential magnetic field strength may be used to calculate the nature of the underlying magnetic rock structure. Specifically, knowledge of the underlying rock structure may facilitate trained geophysicists to predict the location of mineral deposits. Likewise, the production side of oil and gas exploration and production may entail the monitoring of the integrity of oil and gas pipelines and related installations. In some scenarios involving above-ground pipelines, the monitoring of the integrity of oil and gas pipelines and related installations may be performed using digital cameras mounted on one or more UAVs 102.

In some embodiments involving disaster relief, deployment of the UAV 102 may facilitate transportation of medicines and vaccines, and retrieval of medical samples, into and out of remote or otherwise inaccessible regions. Further, the UAV 102 may facilitate in disaster relief by gathering information from across an affected area. Still further, the UAV 102 may facilitate building a picture of the situation and giving recommendations to workforce in connection with managing resources to mitigate damage and save lives.

In some embodiments involving forest fire detection, the UAV 102 may facilitate prevention and early detection of forest fires. The possibility of constant flight, both day and night, may render traditional methods, such as helicopters, watchtowers, etc., obsolete. The UAV 102 may comprise cameras and sensors (not shown and numbered) may provide real-time emergency services, including information about the location of the outbreak of fire as well as many factors, such as wind speed, temperature, humidity, etc., helpful for fire crews to conduct fire suppression.

In some embodiments involving scientific research, the UAV 102 may facilitate penetration, i.e. access, into areas that may be dangerous for manned aircraft.

In some embodiments, the UAV 102 may facilitate conservation of natural and public resources and protection of animal rights.

In some embodiments involving archaeology, deployment of the UAV 102 may facilitate speeding up survey work and protection of sites from squatters, builders and miners. For example, the UAV 102 may facilitate fast generation of Three-Dimensional (3-D) models instead of 2-D maps.

Advantageously, in some embodiments involving the commercial aerial surveillance, deployment of the UAV 102 may facilitate fully autonomous and automatic people and object detection and tracking comprising 1) people and object detection by tracking, and 2) people and object tracking by detection.

Still advantageously, in some embodiments, the UAV 102 may be capable of autonomously and automatically taking off, landing, and flying via design and implementation of Artificial Intelligence (AI) based systems, wherein the UAV 102 may be merely instructed as per the desired mission.

In some embodiments, the UAV 102 may be a powered, aerial vehicle without a human operator on board. Specifically, the UAV 102 may be capable of using aerodynamic forces to provide vehicle lift. More specifically, the UAV 102 may be capable of at least one of flying automatically, autonomously, carrying non-lethal payloads and being remotely piloted, expended and recovered.

In some exemplary embodiments, the UAV may be adapted to fly in apposite altitude ranges, in accordance with the principles of the present invention. For example, and in no way limiting the scope of the invention, the UAV 102 may be allowed to, and thus adapted to fly at altitudes ranging from a minimum of approximately 30 m to a maximum of approximately 120 m, as per the guidelines of the Civil Aviation Safety Authority (CASA) or Australian National Aviation Authority (NAA).

In some embodiments, the UAV may be adapted to fly in one or more altitude ranges based on one or more national and supra-national civil aviation authorities, guidelines thereof and explicit approval therefrom, in accordance with the principles of the present invention. For example, in the event the UAV 102 may be required to fly outside the altitude range, i.e. at least one of below and above, specified by the CASA, an explicit approval may be sought from the CASA. Specifically, the UAV 102 with the RFID reader 104 as a payload may be allowed to fly lower on private lands subject to explicit approval from land owners.

In some preferred embodiments, the UAV 102 may possess the following specifications: A) the type or modality may be a quadcopter or quadricopter 102; B) the flying altitude of the quadcopter 102 may range from a minimum of approximately 30 m to a maximum of approximately 70 m, for instance by virtue of being capable of flying at the altitudes ranging from a minimum of approximately 30 m to a maximum of approximately 70 m, the quadcopter 102 may facilitate achievement of a reliable range for an RFID reader to pick up RFID signals; C) the overall weight of the quadcopter 102 may be approximately 2 kg; D) the add-on components at least one of integrably and externally coupled to the quadcopter 102 may be at least one of 1) video cameras, 2) electromagnetic spectrum sensors, for instance gamma ray sensors, biological sensors, chemical sensors and a combination thereof, 3) electromagnetic sensors, for instance visual spectrum, infrared, near infrared cameras, radar systems and a combination thereof, 4) electromagnetic wave detectors, for instance microwave, ultraviolet spectrum sensors and a combination thereof, 5) Global Positioning System (GPS) receivers and a combination of 1), 2), 3), 4) and 5).

In some embodiments, each of one or more UAVs 102 comprising an RFID reader 104 as a payload may be flown at least simultaneously in order to triangulate data to calculate position of a given asset.

In some embodiments, the UAV 102 may comprise an inbuilt camera with a display (not shown and numbered) thereby facilitating providing a variety of information, such as altitude, latitude, longitude, ambient information, signal and battery strength. In some embodiments, the UAV 102 may comprise battery indicators (not shown and numbered).

In some embodiments, the UAV 102 may comprise both the RFID reader 104 and a Personal Digital Assistant (PDA) (not shown and numbered) as a combined payload, which are powered by a battery (not shown and numbered) thereof.

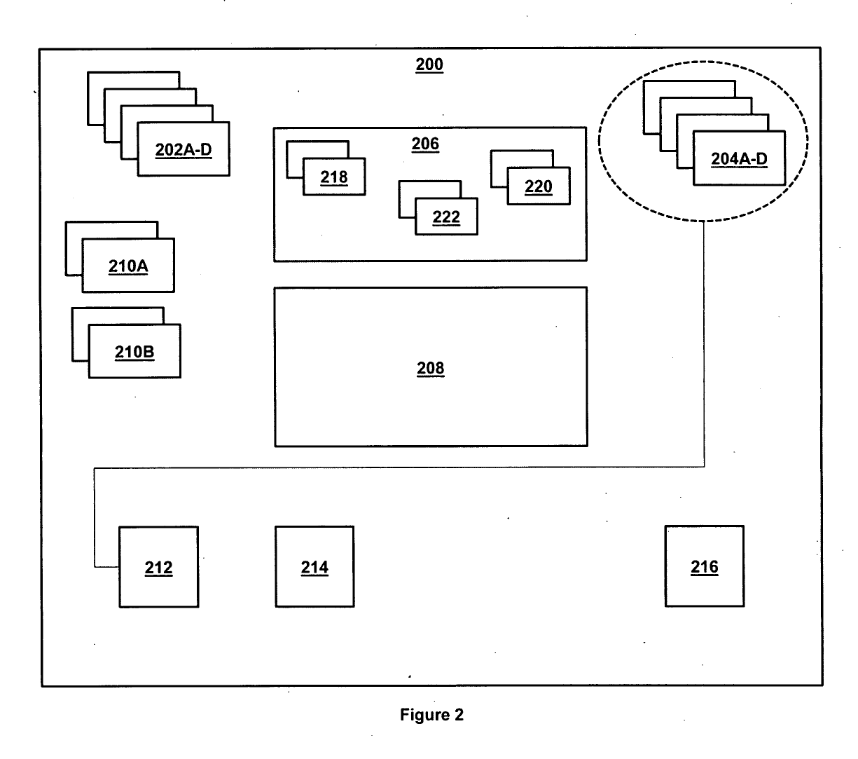

FIG. 2 depicts a block diagram of the quadcopter designed and implemented, in accordance with one or more embodiments based on the principles of the invention.

As depicted in FIG. 2, in some embodiments, the quadcopter 102 may comprise a framework 200, one or more motors 202, one or more Electronic Speed Controls (ESCs) 204, a flight control board 206, a radio transmitter and receiver 208, one or more propellers or rotors 210, a battery 212, charger 214 and an RFID reader 216.

In some embodiments, the RFID reader 216 may be coupled to the quadcopter 102. For example, and in no way limiting the scope of the invention, the RFID reader 216 may be at least one of integrably (or integrally) and externally coupled to the quadcopter 102.

The framework 200 may facilitate housing all the components of the quadcopter 102. Identification and selection of the framework 200 is based on one or more factors, such as the weight, size, and material of the framework 200. In some exemplary embodiments, the framework 200 may possess apposite geometrical, dimensional, material, weight and constructional specifications: for example, and in no way limiting the scope of the invention, the material of the framework 200 may be at least one of carbon fiber composites, aluminium and balsa; the weight of the framework 200 may be light; the framework 200 may be rugged and stiff, and the rest.

The one or more motors 202 may facilitate spinning or rotation of the propellers or rotors 210. As a general rule, the motors are rated by Kilovolts (kVs), and the higher the kV rating, the faster the motor spins at a constant voltage. Identification and selection of the motors 202 is based on the size of propeller 210. For example, and in no way limiting the scope of the invention, the total number of the motors may be at least four (4). For purposes of clarity and expediency, the 4 motors may be hereinabove and hereinafter collectively referred to as 4 motors or motors 202. For purposes of further clarity and expediency, the 4 motors 202 may be hereinafter separately referred to as a first, second, third and fourth motors 202A, 202B, 202C and 202D respectively.

The Electronic Speed Controls (ESCs) 204 may facilitate controlling and managing the speed of spinning (or rotation) of the rotors or propellers 210 at any given time. For example, and in no way limiting the scope of the invention, at least four (4) ESCs 204 may be required for the quadcopter 102, wherein each of the four ESCs 204 is coupled to each of the four motors 202. For purposes of clarity and expediency, the four ESCs may be hereinabove and hereinafter collectively referred to as four ESCs or ESCs 204. For purposes of clarity and expediency, the four ESCs may be hereinafter separately referred to as a first, second, third and fourth ESCs 204A, 204B, 204C and 204D four ESCs or ESCs 204, respectively. For purposes of still further clarity and expediency, the four ESCs 204 may be hereinafter interchangeably referred to as at least one of four ESCs or ESCs 204 collectively and a first, second, third and fourth ESCs 204A, 204B, 204C and 204D separately, respectively.

The ESCs 204 may be coupled directly to the battery 212 through at least one of wiring harness and power distribution board (not shown and numbered here explicitly). In some embodiments, each of the ESCs 204A-D may further comprise a built-in Battery Eliminator Circuit (BEC) (not shown and numbered here explicitly), which may facilitate powering the flight control board 206 and radio receiver 208 of the quadcopter 102 without connecting the flight control board 206 and radio receiver 208 directly to the battery 212.

Owing to the fact that all the four motors 202A-D on the quadcopter 102 may have to spin at precise speeds to achieve accurate flight, thus the ESCs 204A-D may play a significant role. In some embodiments, the ESCs 204A-D may further comprise a firmware (not shown and numbered here explicitly). The firmware may facilitate altering the refresh rate of the ESCs 204A-D such that the motors 202A-D get higher number of instructions per second from the ESCs 204A-D, thereby facilitating greater control over the behaviour of the quadcopter 102.

In some embodiments, the quadcopter 102 may comprise both the RFID reader 104 and a Personal Digital Assistant (PDA) (not shown and numbered) as a combined payload, which are powered by the battery 212 thereof.

As used in general, the term “Electronic Speed Control or ESC” refers to an electronic circuit capable of varying the speed of an electric motor, the direction and possibly serving as a dynamic brake. ESCs are often used on electrically powered radio controlled models, with the variety most often used for brushless motors essentially providing an electronically-generated three phase electric power low voltage source of energy for the motor.

The flight control board 206 is the brain of the quadcopter 102.

In some embodiments, the flight control board 206 may facilitate the user to mark waypoints on a map (not shown and numbered here explicitly), to which quadcopter 102 may fly and perform tasks, such as landing or gaining altitude. Specifically, the waypoints may be marked on a map rendered on the display of a portable computing and communications device (not shown and numbered here explicitly), such as a tablet or pc device, to create a flight plan.

The flight control board 206 may comprise one or more sensors 218, gyroscopes 220 and accelerometers 222 thereby facilitating determination of the speed of rotation of each of the four motors 202 of the quadcopter 102.

The radio transmitter and receiver 208 may facilitate controlling the quadcopter 102. For example, and in no way limiting the scope of the invention, a radio transmitter and receiver 208 with at least four (4) channels may be required for the quadcopter 102.

In some embodiments, the quadcopter 102 may comprise one or more pairs of rotors. For example, and in no way limiting the scope of the invention, the quadcopter 102 may comprise at least Two (2) pairs of rotors. For purposes of clarity and expediency, the two pairs of rotors may be hereinafter referred to as a first and second pair of propellers 210A and 210B. Each rotor of the two pairs of rotors 210A and 210B may be at least one of vertically oriented, fixed pitched propeller and a combination thereof. Specifically, the first pair of propellers 210A may be capable of performing Clock-Wise (CW) rotation, whereas the second pair of propellers 210B may be capable of performing Counter-Clockwise (CCW) rotation.

For example, and in no way limiting the scope of the invention, the propellers or pairs of rotors 210A and 210B may be at least one of fixed- and variable pitch propellers. In some embodiments, the motors 202 and the propellers 210A and 210B may be positioned equidistant to each other for best performance of the quadcopter 102.

By virtue of design, the quadcopter 102 may facilitate varying the pitch angle of the rotor blade as the two pairs of rotors 210A and 210B spin, in the absence of any mechanical linkage thereby simplifying the design and maintenance of the quadcopter 102. Deployment of the two pairs of rotors 210A and 210B may facilitate each rotor of the pairs of rotors 210A and 210B to have a smaller diameter vis-à-vis the equivalent rotor of the helicopter, thereby facilitating the pairs of rotors 210A and 210B to possess less kinetic energy during flight, which in turn facilitates reduction of the damage caused in the event of any collision. In some embodiments involving deployment of small-scale UAVs or quadcopters, the smaller diameter of each of the pairs of rotors 210A and 210B may facilitate safety of the quadcopter 102 during close interaction. Specifically, some small-scale quadcopters may have frames that enclose the rotors, permitting flights through more challenging environments, with lower risk of damaging the vehicle or its surroundings.

In operation, each rotor of the two pairs of rotors 210A and 210B may produce both a thrust and torque about the center of rotation of the corresponding to each rotor, as well as a drag force opposite to the direction of flight of the quadcopter 102. In the event that all of the two pairs of rotors 210A and 210B are spinning at the same angular velocity, wherein the first pair of rotors 210A are rotating clockwise, and wherein the second pair of rotors 210B are rotating counterclockwise, the net aerodynamic torque, and hence the angular acceleration about the yaw axis, is exactly zero, which implies that the yaw stabilizing rotor of conventional helicopters is not needed. Yaw is induced by mismatching the balance in aerodynamic torques (i.e., by offsetting the cumulative thrust commands between the counter-rotating blade pairs).

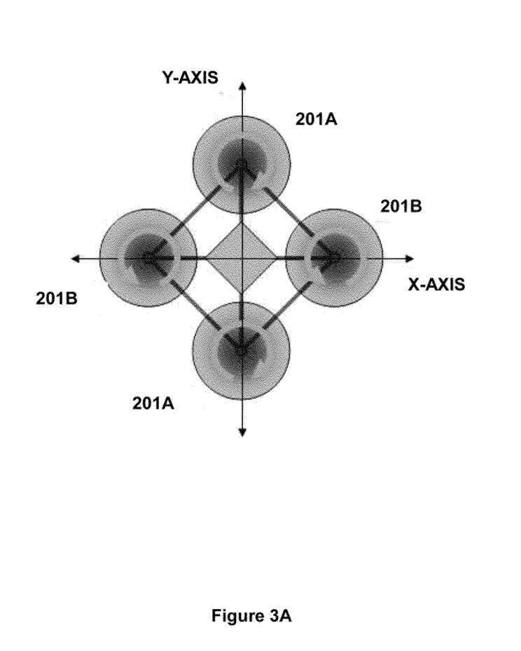

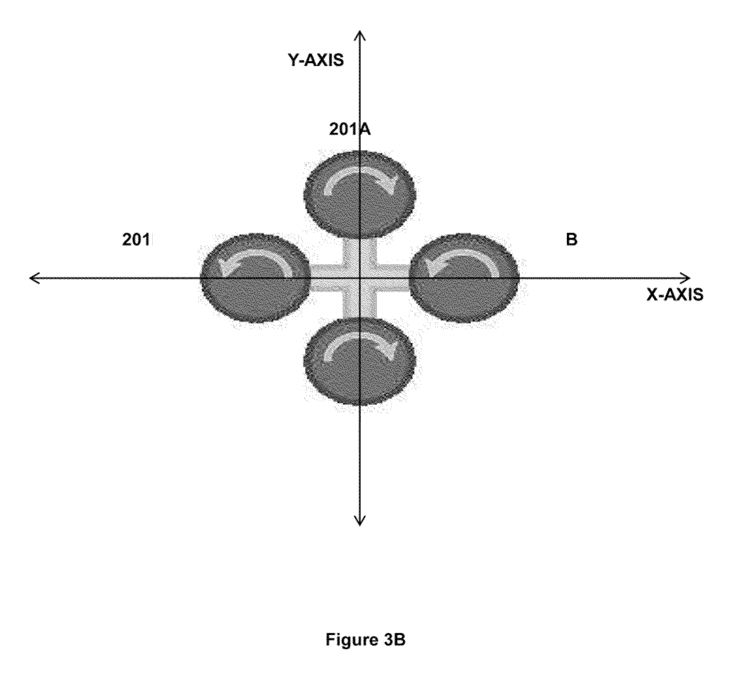

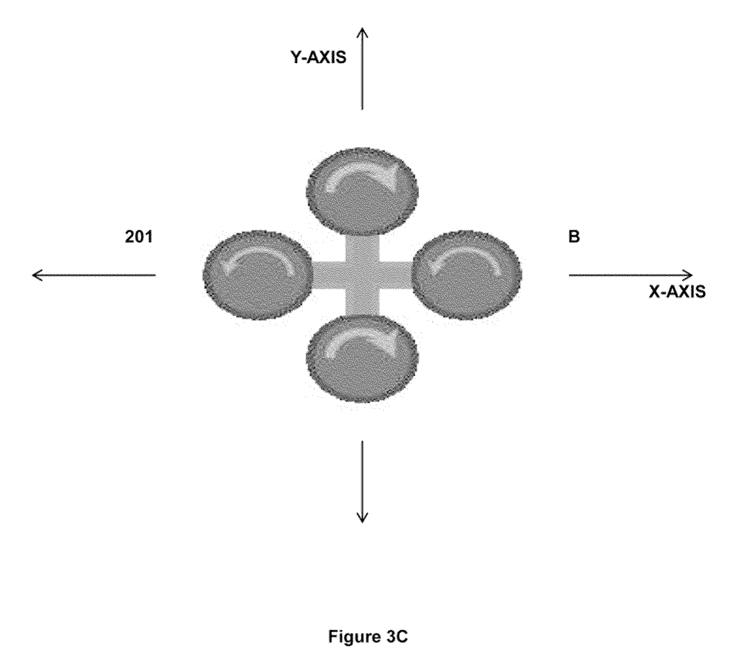

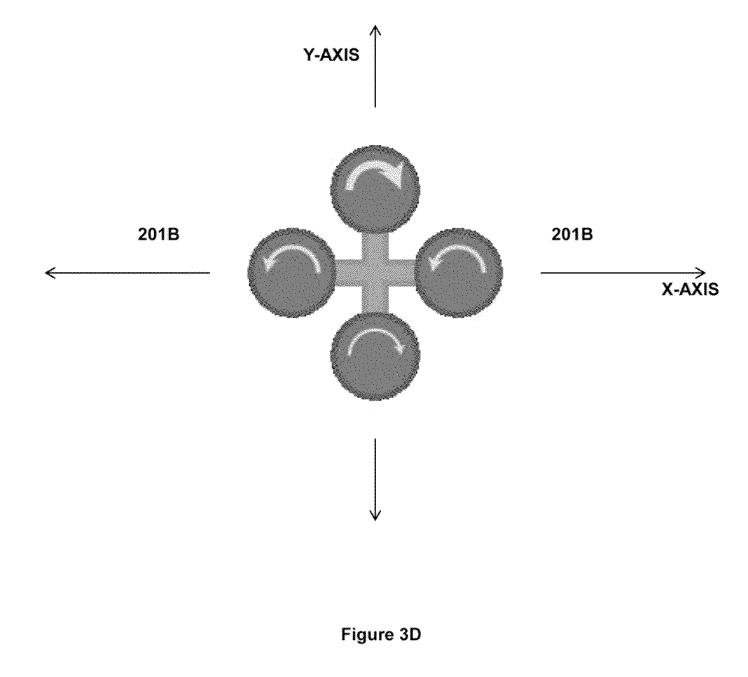

FIG. 3A depicts a schematic representation of the reaction torques on each motor of a quadcopter aircraft, due to spinning rotors.

As depicted in FIG. 3A, the first pair of rotors 201A spins in one direction, for instance clockwise direction, while the second pair of rotors 201B spins in the opposite direction, for instance counterclockwise direction, thereby yielding opposing torques for control.

FIG. 3B depicts the autonomous adjustment of the altitude of flying by the quadcopter via application of equal thrust to the Two (2) pairs of rotors, according to one or more embodiments.

FIG. 3C depicts the autonomous adjustment of the yaw by the quadcopter via application of relatively higher thrust to the first pair of rotors rotating in clockwise direction vis-à-vis the second pair of rotors rotating in counterclockwise direction, according to one or more embodiments.

FIG. 3D depicts the autonomous adjustment of the pitch or roll via application of relatively higher thrust to the one rotor and lower to the another positioned diametrically opposite thereto of the first pair of rotors rotating in clockwise direction, according to one or more embodiments.

In general, the RFID systems may be classified based on the type of tag and reader. Specifically, the RFID systems may be classified into the following types: 1) a Passive Reader Active Tag (PRAT) RFID system may comprising a passive RFID reader, which may only receive radio signals from active RFID tags (battery operated, transmit only). The reception range of the PRAT RFID system reader may be adjusted from 1-2,000 feet (0.30-609.60 m), thereby facilitating flexibility in applications, such as asset protection and supervision; 2) an Active Reader Passive Tag (ARPT) RFID system may comprise an active RFID reader, which transmits interrogator signals and also receives authentication replies from passive RFID tags; and 3) an Active Reader Active Tag (ARAT) RFID system may use active RFID tags awakened with an interrogator signal from the active RFID reader. A variation of the ARAT RFID system may also use a Battery-Assisted Passive (BAP) RFID tag, which may act like a passive RFID tag but may have a small battery to power the return reporting signal of the BAP RFID tag.

In some embodiments, the RFID reader may be capable of transmitting an encoded radio signal to interrogate the RFID tag. The RFID tag, for instance the RFID tag 106 of FIG. 1, may be capable of receiving a message, i.e. the encoded radio signal as carrier signal with payload as a message. The RFID tag may be capable of responding with the RFID and other information corresponding to the RFID tag. For example, and in no way limiting the scope of the invention, the RFID and other information may be at least one of a unique tag serial number, product-related information, for instance a stock, lot, batch number, production date, and other specific information. In some embodiments, secured signals may also be used to track sensitive data, wherein the radio signals are encoded and decoded upon return of the quadcopter 102 to the base to avoid the risk of data theft.

In some scenarios involving deployment of a given enterprise system software for materials or physical assets management, in operation, the RFID reader 216 may facilitate connection between the data or information stored in the RFID tags, for instance the RFID tags 106 of FIG. 1, and a given enterprise system software, which may need the information. Specifically, the RFID reader 216 may be capable of communicating with RFID tags in the field of operation thereof, thereby performing any number of tasks including, but not limited to, simple continuous inventorying, filtering, for instance searching for the RFID tags meeting at least one of explicit user-definable and implicit pre-definable criteria, writing (or encoding) to selected RFID tags, etc. More specifically, the RFID reader 216 may be capable of at least one of assigning zones, updating locations, and a combination thereof via GPS for the RFID tags.

In some embodiments, in use, each of the RFID tags may be used to designate one or more items of assets (or materials) with an electronic identity, which may be encoded and read by the RFID reader. The RFID reader may be capable of propagating a particular RF signal. Upon entering the detection range of the RFID reader, a given RFID tag may transmit a return signal. The RFID tag 106, of FIG. 1, may facilitate modulation of the return signal to include information in connection with the asset comprising one or more qualitative and quantitative parameters including, but not limited to, the protocol of the RFID tag, managing organization, asset description, and serial number. For example, and in no way limiting the scope of the invention, the information may be commonly stored as a 96-bit string of data called an Electronic Product Code (EPC). The RFID reader may be capable of determining the accuracy of the EPC by the use of an error correcting code algorithm. Upon determining the accuracy of the EPC, the RFID reader may be capable of relaying the information of the RFID tag to a system user, server, or database, which may update the data or information of the RFID tag, as needed.

In some embodiments, the RFID reader may be capable of sensing (or reading) multiple RFID tags within the detection range of the RFID reader. Specifically, the RFID reader may be capable of reading multiple RFID tags via sequentially reading each individual RFID tag of the RFID tags thereby facilitating comprehension of each individual RFID tag. In some scenarios involving bulk reading of RFID tags by an RFID reader, the RFID reader may be programmed with collision detection to formulate a protocol to scan and organize each tag thereby facilitating minimization or reduction of the time for identification of each individual tag embedded on each individual item of materials. For example, and in no way limiting the scope of the invention, at least Two (2) anti-collision algorithms may be encoded into a RF signal emanated from the RFID reader. Firstly, for probabilistic detection, the RFID tag is assigned a random time delay. In the event that a collision occurs, one or more RFID tags with signals that are not read may be randomly assigned an available timeslot. The assignment of available timeslot to unread RFID tags, and signals therefrom, may continue until all the RFID tags within the detection range are read. Secondly, on the contrary, deterministic detection is typically quicker than probabilistic detection. Specifically, the deterministic detection method may rely on the underlying binary code of the RFID tag, which may be read bit-by-bit. In some scenarios involving implementation of the deterministic detection method, no tags may be read more than once, and the scan time may be directly related to the number of RFID tags. In some scenarios involving deployment and implementation of two readers with an overlapping detection field, to prevent the RFID readers from scanning the same tag simultaneously, the RFID readers may alternate between random frequencies within the corresponding bandwidth therefor in a process known as frequency hopping.

In operation, the RFID readers and antennas thereof may cooperate in coordination to read the RFID tags. The antennas of the RFID reader may be capable of converting electrical current into electromagnetic waves. Upon conversion, the electromagnetic waves may be radiated into space. The radiated electromagnetic waves may be received by the antenna of the RFID tags. The RFID tags and antenna thereof may be capable of converting the received electromagnetic waves back to electrical current. Thus, selection of an optimal antenna for the RFID reader varies according to the specific application and environment in connection with a given solution.

In general, the two most common antenna types are linear- and circular-polarized antennas. Specifically, the antennas that radiate linear electric fields have long ranges, and high levels of power that enables the signals therefrom to penetrate through different materials to read the RFID tags. More specifically, the linear antennas may be sensitive to the orientations of the RFID tags depending on the angle or placement of the RFID tags. The linear antennas may have a difficult time reading the RFID tags. Conversely, the antennas that radiate circular fields are less sensitive to orientations of the RFID tags, but may not be able to deliver as much power as the linear antennas.

Further, the selection of the antenna may also be determined by the distance between the RFID reader and the RFID tags to be read by the RFID reader. For purposes of clarity and expediency, the distance between the RFID reader and the RFID tags to be read by the RFID reader may be referred to as the read range. The antennas of the RFID readers may be capable of operating in at least one of near-field (short range) and far-field (long range). In near-field applications, the read range is less than 30 cm and the antenna uses magnetic coupling so the RFID reader and RFID tag may be capable of transferring power. In near-field systems, the readability of the RFID tags is not affected by the presence of dielectrics, such as water and metal in the field. In far-field applications, the range between the RFID tag and RFID reader is greater than 30 cm and may be up to several tens of meters. Far-field antennas utilize electromagnetic coupling and dielectrics may weaken communication between the RFID reader and RFID tags.

In some embodiments, the RFID reader may facilitate detecting or identifying, interrogating, and amending one or more RFID tags. Each of the RFID tags may assign a unique electronic identity to a physical article. In operation, the RFID reader and the RFID tags may be capable of exchanging information via usage of at least one of short-range and long-range RF signals.

In some exemplary embodiments, the RFID reader 216 may possess the following technological, interfacial, performance and qualitative specifications: 1) technology type of the RFID reader 216 may be at least one of active RFID reader and passive RFID reader; 2) interface type of the RFID reader 216 may be wireless; 3) frequency utilized by the RFID reader 216 may be at least one of Low Frequency (LF) in the 120-150 kHz Band, High Frequency (HF) at 13.56 MHz, Ultra-High Frequency (UHF) at 433 MHz, Industrial, Scientific and Medical (ISM) Band Microwave in the 2450-5800 MHz Band and Ultra-Wide Band (UWB) in the 3.1-10 GHz Band; 4) access permissions may at least one of read, write and a combination thereof; 5) portability; 6) anti-collision and multi-readability; 7) Contactless; 8) encryptability; 9) continuous reportability; 10) read rate or reading performance may vary from a minimum of approximately ten to a maximum of 100 RFID tags per second; 11) detection range may vary from a minimum of approximately 70 m to a maximum of approximately 100 m; 12) operating temperature may vary from a minimum of approximately −10° C. to a maximum of approximately 50° C.; 13) storage temperature may vary from a minimum of approximately −20° C. to a maximum of approximately 60° C.; 14) sustained/gust wind tolerance or resistance range may be approximately 30 Knots; 15) read range may be at least one of long and short range; 16) antenna type may be at least one of a linear- and circular-polarized antenna, and the like.

In some embodiments, the RFID reader may be in essence an RFID interrogator. The RFID reader may comprise a RF transmitter and receiver, controlled by a microprocessor or digital signal processor. In operation, the RFID reader may be capable of capturing data from the RFID tags. Upon capture of the data, the RFID reader may transfer the captured data to the microprocessor or digital signal processor for further processing.

In some embodiments, the mode of identification of the RFID tag by the RFID reader depends on the type of the RFID tag, for instance at least one of active, passive and Batter-Assisted Passive (BAP). In some embodiments, Hybrid RFID tags may be deployed with both Active and Passive as well as GSM facility.

In some embodiments, the RFID tag may be at least one of passive, active and BAP. In some scenarios involving deployment of a passive RFID tag, the passive RFID tag may be cheaper and smaller because the passive RFID tag has no battery. However, to start operation, the passive RFID tag must be illuminated with a power level roughly three magnitudes stronger than for signal transmission thereby leading to the difference in interference and in exposure to radiation.

In some scenarios involving deployment of BAP RFID tags, the BAP RFID tag may comprise a small on-board battery (not shown and numbered here explicitly). The BAP RFID tag may be capable of being activated in the presence of the RFID reader.

For example, and in no way limiting the scope of the invention, the RFID tag may be active RFID tag. Specifically, the active RFID tag may comprise an on-board battery (not shown and numbered here explicitly).

In some scenarios involving deployment of the active RFID tags, the active RFID tag may be capable of periodically transmitting a corresponding Identification (ID) signal, for instance the RF signal of the active RFID tag. In use, the RF signal of the active RFID tag may be registered by the RFID reader.

In some embodiments, the RFID tags may comprise an Integrated Circuit (IC) and antenna. Specifically, the IC may be capable of storing and processing information, modulating and demodulating RF signal, collecting DC power from the incident signal from the RFID reader, and other specialized functions. The antenna may be capable of receiving and transmitting the signal. The RFID tag information is stored in a non-volatile memory. In some embodiments, the RFID tag may comprise at least one of a chip-wired logic and programmed and programmable data processor for processing the transmission and sensor data, respectively.

In operation, active RFID tags 106, of FIG. 1, may be capable of periodically transmitting the RFID signal corresponding to the active RFID tags 106. The RFID signal may be registered by the RFID reader 216. In some embodiments, specifically, the active RFID tags 106 may require a charge in the IC and antenna, and the active RFID tags 106 may have a larger range because of an integrated battery. In some scenarios involving deployment of at least one of a semi-active (i.e. the IC may be charged, but not the antenna) and passive (i.e. no battery and no charge) RFID tags, the RFID tags may have to wait for the initial RF signal from the RFID reader before broadcasting the return signal. Since passive RFID tags have no battery to charge the IC, the initial magnetic field radiated by the RFID reader must be threefold the field needed to maintain communication. RFID Readers compatible with passive RFID tags may require a larger, in-phase coil antenna as well.

In some embodiments, the active RFID tags 106 may require a charge in the IC and antenna, wherein the active RFID tags 106 may have a larger range because of an integrated battery. In the instance of semi-active (the circuit is charged, but not the antenna) or passive (there is no battery and no charge) RFID tags, the tags wait for the initial RF from the reader before broadcasting the return signal. Since passive tags have no battery to charge the circuit, the initial magnetic field radiated by the reader must be threefold the field needed to maintain communication. Readers compatible with passive tags require a larger, in-phase coil antenna as well.

The RFID tags 106 may facilitate wireless identification and tracking of assets (or materials) via RF interaction with the RFID readers 216. In some embodiments, the RFID tag 106 may comprise an Integrated Circuit (IC) and an antenna (all not shown and numbered here explicitly).

In some embodiments, the RFID tags 106 may be also assigned an operational identity to prevent the RFID tags 106 from misuse. In some embodiments, the RFID tags 106 may be classified into the following types: 1) read-only RFID tags 106 may comprise a factory-programmed serial number which cannot be altered, and therefore cannot be misread or corrupted. A complementary internal database may be used to add supplemental information to the serial number; 2) read/write RFID tags 106 may facilitate the inherited information rewritten or altered by a system user and chip reader. The inherited information may be stored in the memory of the chip of the read/write RFID tags 106; and 3) write-once RFID tags 106 may be assigned an identity by a system user only once, but it may be read many times.

In some embodiments, the RFID tags 106 may be at least one of read-only and read/write. Specifically, the read-only RFID tag may comprise a factory-assigned serial number that is used as a key into a database, whereas the read/write RFID tag thereby facilitating writing an object-specific data into the tag by the system user. More specifically, field programmable RFID tags may be Write-Once, Read-Multiple (or Many Times) (or WORM). Further, blank tags may be written with an Electronic Product Code (EPC) by the user.

For example, and in no way limiting the scope of the invention, the RFID tag 106 may be active RFID tag.

In some embodiments, the active RFID tag 106 may comprise an on-board battery. The active RFID tag 106 may be capable of periodically transmitting an Identification (ID) signal corresponding to the active RFID tag.

The IC of the active RFID tag 106 may be capable of storing and processing information, modulating and demodulating a RF signal, collecting DC power from the incident signal from the RFID reader 216, and other specialized functions.

The antenna of the active RFID tag 106 may be capable of receiving and transmitting the signal. The tag information may be stored in a non-volatile memory. The active RFID tag 106 may comprise a chip-wired logic or a programmed or programmable data processor for processing the transmission and sensor data, respectively.

In some embodiments, the RFID tag may possess the following technological and performance specifications: 1) underlying technology may be at least one of passive, semi-passive and active; 2) frequency utilized may be at least one of Low Frequency (LF) in the 120-150 kHz Band, High Frequency (HF) at 13.56 MHz, Ultra-High Frequency (UHF) at 433 MHz, Industrial, Scientific and Medical (ISM) Band Microwave in the 2450-5800 MHz Band and Ultra-Wide Band (UWB) in the 3.1-10 GHz Band and the like.

In some embodiments, the quadcopter 102 may comprise long range WiFi connectivity, if required.

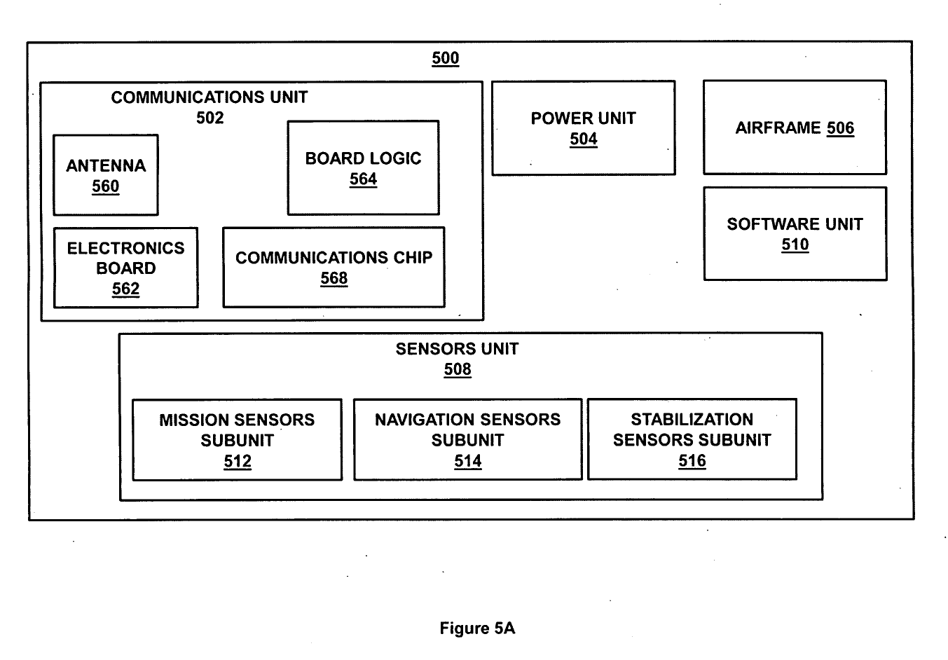

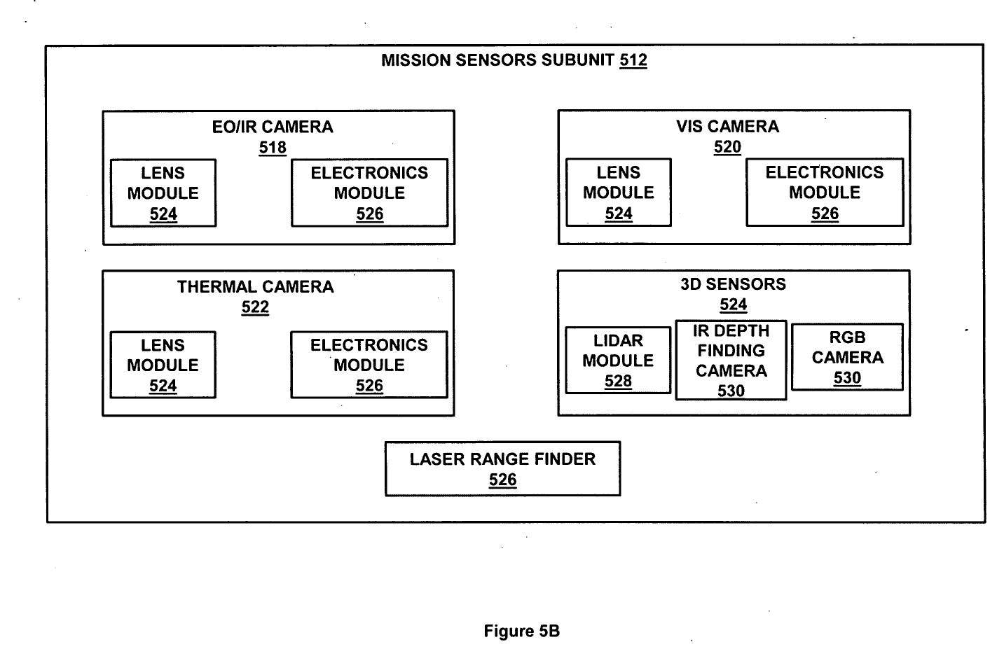

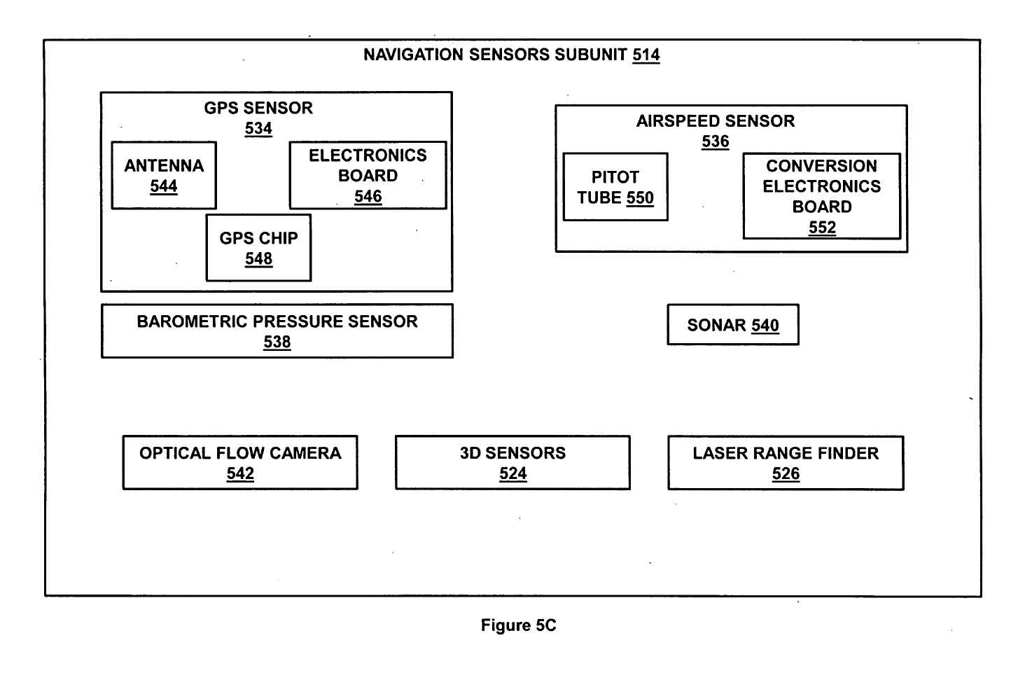

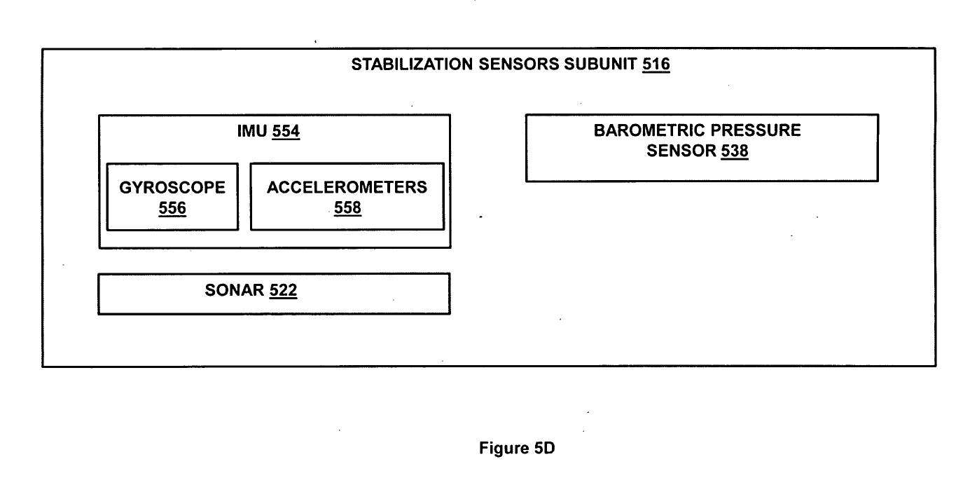

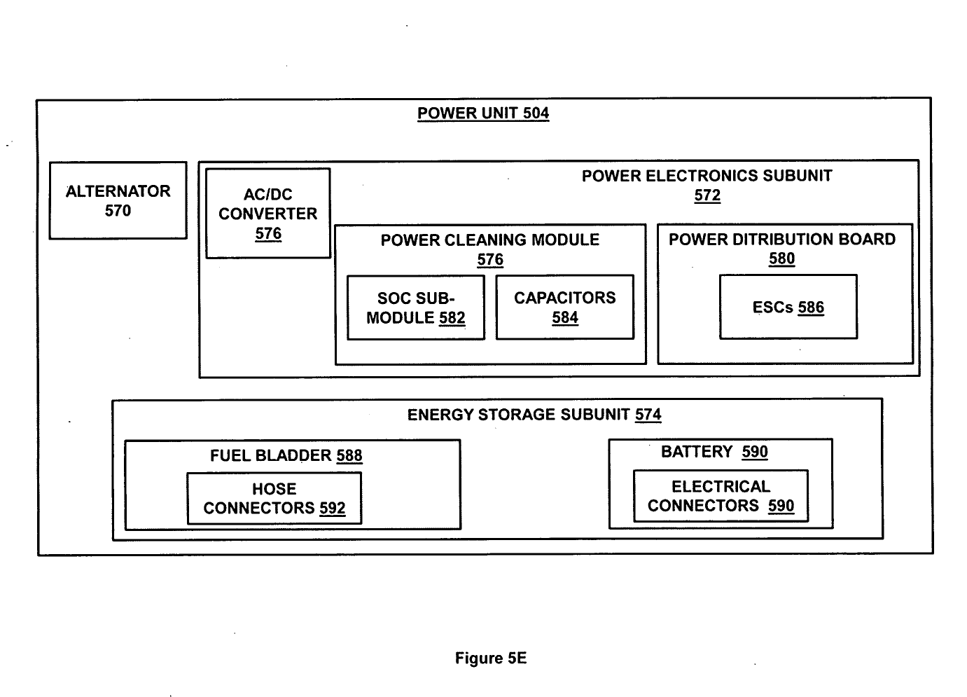

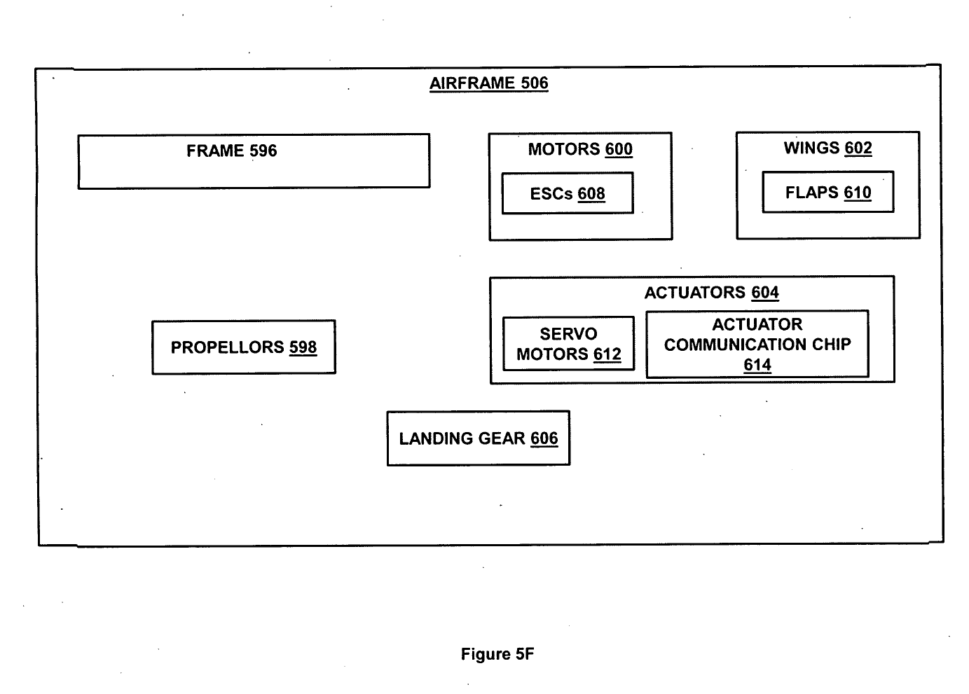

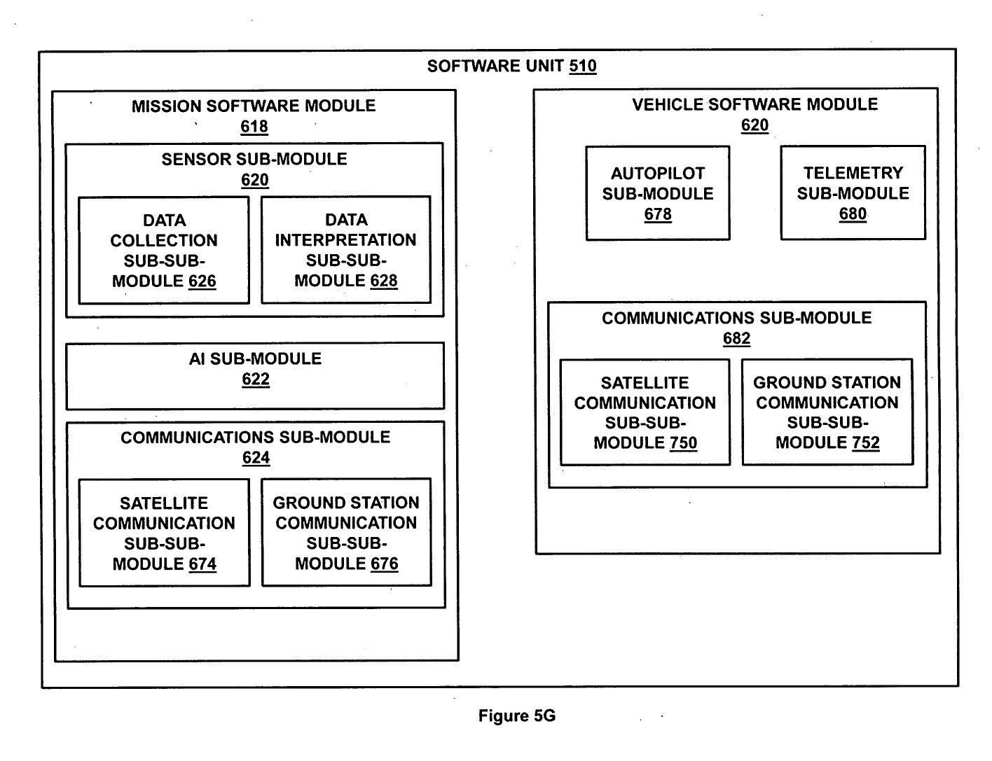

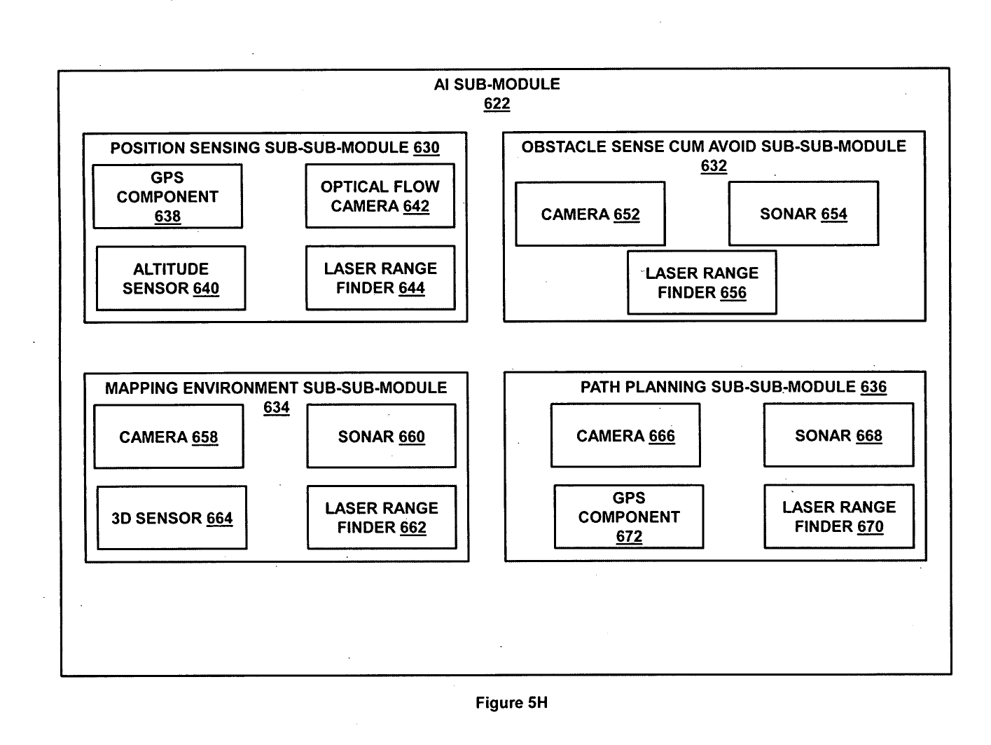

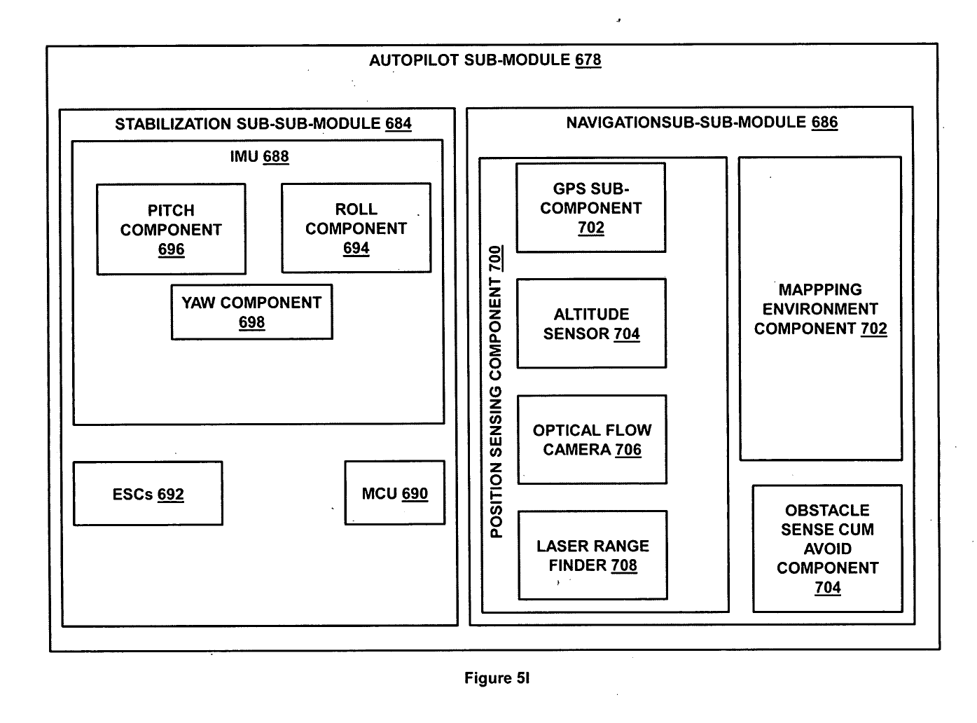

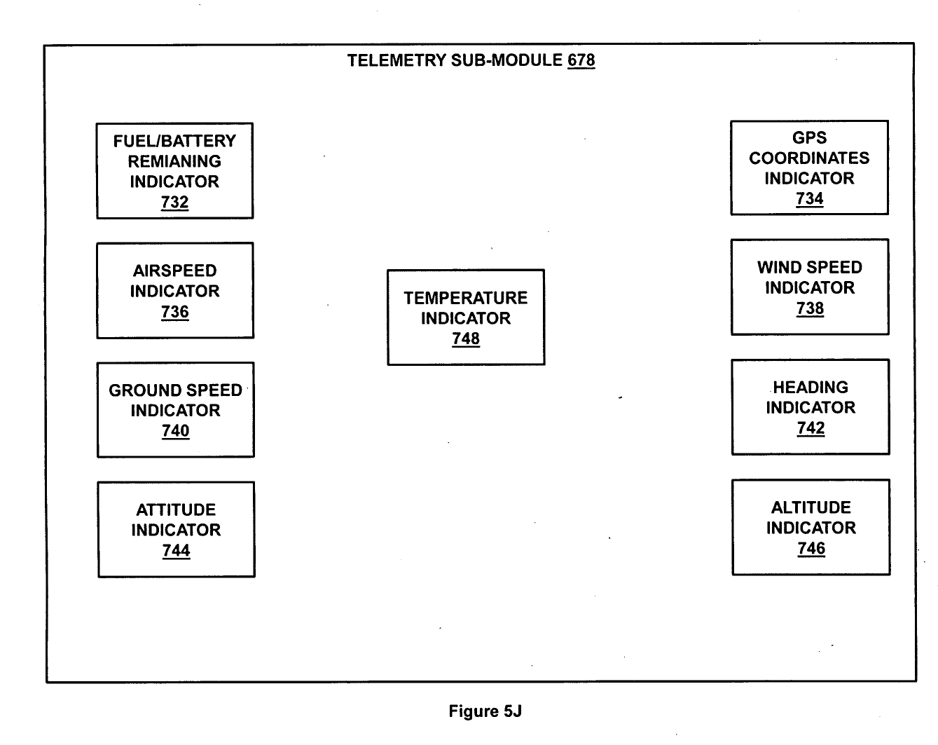

FIG. 5A depicts a block diagram of the UAV (or quadcopter), and components thereof, according to one or more embodiments.

In some advanced embodiments, as depicted in FIG. 5A, the UAV (or quadcopter) 500 may comprise a communications unit 502, power unit 504, airframe 506, sensors unit 508 and software unit 510.

The sensors unit 508 may comprise one or more set of sensors, namely a mission sensors subunit 512, navigation sensors subunit 514 and stabilization sensors subunit 516.

As depicted in FIG. 5A, the communications unit 502 may comprise a board logic 564, communications chip 568, an antenna 560 and electronics board 562.

FIG. 5B depicts a block diagram of the mission sensors subunit 512 of FIG. 5A.

The mission sensors subunit 512 may comprise at least one of a hybrid Electro-Optical/Infrared (EO/IR) camera 518, VIS camera 520, thermal camera 522, 3D sensors 524, laser range finder 526 and a combination thereof.

Each one of the hybrid EO/IR camera 518, VIS camera 520 and thermal camera 522 may comprise a lens module 524 and electronics module 526. However, the 3D sensors 524 may comprise a LIDAR module 528 and at least one of RGB camera 530, IR depth finding camera 532, and a combination thereof.

FIG. 5C depicts a block diagram of the navigation sensors subunit 514 of FIG. 5A.

The navigation sensors subunit 514 may comprise at least one of a GPS sensor 534, an airspeed sensor 536, a barometric pressure sensor 538, sonar 540, an optical flow camera 542, the 3D sensors 524, the laser range finder 526 and a combination thereof.

The GPS sensor 534 may comprise an antenna 544, electronics board 546 and a GPS chip 548.

The airspeed sensor 536 may comprise a pitot tube 550 and conversion electronics board 552.

FIG. 5D depicts a block diagram of the stabilization sensors subunit 516 of FIG. 5A.

The stabilization sensors subunit 516 may comprise an Inertial Measurement Unit (IMU) 554, the barometric pressure sensor 538 and the sonar 540.

The IMU 554 may comprise a gyroscope 556 and one or more accelerometers 558.

FIG. 5E depicts a block diagram of the power unit 504 of FIG. 5A.

The power unit 504 may comprise an alternator 570, a power electronics subunit 572 and an energy storage subunit 574.

The power electronics subunit 572 may comprise one or more AC/DC converter 576, a power cleaning module 578 and a power distribution board 580.

The power cleaning module 578 may comprise a Silicon-on-Chip (SOC) sub-module 582 and one or more capacitors 584.

The power distribution board 580 may comprise one or more Electronic Speed Controllers (ESCs) 586.

The energy storage subunit 574 may comprise a fuel bladder 588 and battery 590. The fuel bladder 588 may comprise one or more hose connectors 592. The battery 590 may comprise one or more electrical connectors 594.

FIG. 5F depicts a block diagram of the airframe 506 of FIG. 5A.

The airframe 506 may comprise a frame 596, one or more propellers 598, one or more motors 600, one or more wings 602, one or more actuators 604 and landing gear 606.

The one or more motors 600 may comprise one or more ESCs 608. The one or more wings 602 may comprise one or more flaps 610.

The one or more actuators 604 may comprise one or more servo motors 612 and an actuator communication chip 614.

FIG. 5G depicts a block diagram of the software unit 510 of FIG. 5A.

The software unit 510 may comprise a mission software module 618 and vehicle software module 620.

The mission software module 618 may comprise a sensor sub-module 620, an Artificial Intelligence (AI) sub-module 622 and a communications sub-module 624.

The vehicle software module 620 may comprise an autopilot sub-module 678, a telemetry sub-module 680 and a communications sub-module 682.

The sensor sub-module 620 may comprise a data collection sub-sub-module 626 and data interpretation sub-sub-module 628.

The communications sub-module 624 may comprise a satellite communication sub-sub-module 674 and a ground station communication sub-sub-module 676.

The communications sub-module 682 may comprise a satellite communication sub-sub-module 750 and a ground station communication sub-sub-module 752.

FIG. 5H depicts a block diagram of the AI sub-module 622 of FIG. 5G.

The Artificial Intelligence (AI) sub-module 622 may comprise a position sensing sub-sub-module 630, an obstacle sense cum avoid sub-sub-module 632, a mapping environment sub-sub-module 634, and path planning sub-sub-module 636.

The position sensing sub-sub-module 630 may comprise a GPS component 638, an altitude sensor 640, an optical flow camera 642, and a laser range finder 644.

The GPS component 638 may comprise a waypoint sub-component 646, a geofence sub-component 648, and follow target sub-component 650.

The obstacle sense cum avoid sub-sub-module 632 may comprise a camera 652, sonar 654, and a laser range finder 656.

The mapping environment sub-sub-module 634 may comprise a camera 658, sonar 660, laser range finder 662, and a 3D sensor 664.

The path planning sub-sub-module 636 may comprise a camera 666, sonar 668, laser range finder 670, and a GPS component 672.

FIG. 5I depicts a block diagram of the autopilot sub-module 678 of FIG. 5G.

The autopilot sub-module 678 may comprise a stabilization sub-sub-module 684, and navigation sub-sub-module 686.

The stabilization sub-sub-module 684 may comprise an IMU 688, a Micro Controller Unit (MCU) 690, and one or more ESCs 692.

The IMU 688 may comprise a roll component 694, a pitch component 696, and a yaw component 698.

The MCU 690 may be capable of implementing a stabilization algorithm.

The ESCs 692 may be capable of translating commands to motors.

The navigation sub-sub-module 686 may comprise a position sensing component 700, mapping environment component 702 and an obstacle sense cum avoid component 704.

The position sensing component 700 may comprise a GPS sub-component 702, an altitude sensor 704, optical flow camera 706, and a laser range finder 708.

The GPS sub-component 702 may comprise a waypoint module 710, a geofence module 712, and a follow target module 714.

The mapping environment component 702 may comprise a camera 716, sonar 718, laser range finder 720, and 3D sensor 722.

The obstacle sense cum avoid component 704 may comprise a camera 724, sonar 726, laser range finder 728, and 3D sensor 730.

FIG. 5J depicts a block diagram of the telemetry sub-module 680 of FIG. 5G.

The telemetry sub-module 680 may comprise a fuel/battery remaining indicator 732, GPS coordinates indicator 734, wind speed indictor 738, groundspeed indicator 740, heading indicator 742, temperature indicator 748, an attitude indicator 744, airspeed indicator 736, and altitude indicator 746.

In some operational embodiments involving assets management, one or more of the active RFID tags may be embedded on one or more assets by at least one of off-site suppliers upon delivery and on-site end users upon arrival. Specifically, the serial numbers associated with the active RFID tags may be recorded and stored in a given Enterprise Resource Planning (ERP) system. Upon completion of recording and storage of the serial numbers, the recorded serial numbers may be assigned to the assets with corresponding active RFID tags embedded thereon. The UAV (or quadcopter) may comprise the active RFID reader and the PDA as payloads. In use, the PDA may be capable of running mobile application software for material tracking and management. For example, and in no way limiting the scope of the invention, the mobile application software for material tracking and management may be TRACK'EM® LIVE SOFTWARE. The TRACK'EM® LIVE SOFTWARE is a system that integrates the barcode, RFID and GPS technologies to improve project management on construction sites.

In some scenarios, new assets (or materials) may arrive pre-tagged in a site. Upon arrival, the assets are stored in at least one of a lay-down yard and an installed paddock. Upon storage, the quadcopter may be launched to takeoff and read the active RFID tags on the items of materials (or assets) thereby facilitating updating the status of the items of the materials to “Received.” In addition, the quadcopter may facilitate updating of location of the items of the materials via a GPS receiver. Furthermore, the quadcopter may facilitate verification of the quantity of the items of the materials using the active RFID tags embedded thereon. Thus, the quadcopter may facilitate aerial detection and tracking of the active RFID tags embedded on the items of materials. Specifically, the quadcopter may facilitate at least one of (i) aerial detection by tracking and (ii) aerial tracking by detection. The quadcopter may facilitate capturing the status, for instance, from arrival, to storage, to installation, with respect to the items of the materials by flying through a work site thereby facilitating updating of the status of the items of the materials as “Installed.”

In some scenarios, in the event that one or more active RFID tags may at least one of have to be quarantined and have comments associated thereof, such active RFID tags may be read by manually scanning the same using a portable or handheld RFID reader. For instance, in the event that the operator of the quadcopter picks up an item of a material (or asset), and the active RFID tag embedded thereon, that may be found to be misplaced by virtue of the detected location of the item, the operator may facilitate sending RF signal using the quadcopter to the active RFID tag embedded on the item and may re-write one or more attributes of data. Upon landing, the quadcopter and the PDA thereof may be synchronized and a ground team may go to the detected location, search for the active RFID tag and may read the data or information thereof.

Advantageously, in some scenarios involving at least one of inaccessible, hazardous and heavy machinery deployment sites on the ground, the quadcopter may facilitate avoidance of the need of at least one of vehicles, workforce and a combination thereof, to reach on the aforementioned sites.

Still advantageously, in some embodiments, the quadcopter may facilitate capturing at least one of visuals, videos, audiovisuals, and GPS coordinates therefor, which may be used as at least one of visual, video and audiovisual overlays on the TRACK'EM® LIVE SOFTWARE.

In some advantageous embodiments involving at least one of photography and videography in worst case scenarios based on at least one of terrain, environmental reasons and a combination thereof, the quadcopter may facilitate increased Return-on-Investment (ROI) owing to use of camera and RFID reader as payloads on the quadcopter.

In some advantageous embodiments, the quadcopter may facilitate viewing the camera thereof on the ground thereby providing a bird's-eye view and reducing the need for at least one of an Aerial Work Platform (AWP), Elevating Work Platform (EWP), a Mobile Elevating Work Platform (MEWP), and crane.

In some embodiments, the PDA of the quadcopter may comprise of at least one of 3G and 4G mobile telecommunications technology thereby facilitating real time updates subject to requirements.

In some embodiments, the quadcopter may be adapted to fly at altitudes ranging from a minimum of approximately 30 m to a maximum of approximately 120 m. For example, and in no way limiting the scope of the invention, the quadcopter may be capable of flying at altitudes from a minimum of approximately 30 m to a maximum of approximately 70 m, thereby facilitating achievement of a reliable range for the RFID reader to pick up signals. The UAV also comes in at under 2 kg which means it can be flown without licensing restrictions.

In some embodiments, the active RFID tags may be positioned at one or more strategic locations thereby facilitating clear line-of-sight relative to the sky. Specifically, the active RFID tags are positioned such that the RFID tags may not be in close proximity to each other. In some scenarios, the active RFID tags may be placed at strategic locations, for instance in proximity or vicinity of metal or water bodies so as to assess performance thereof. In some scenarios involving the flight of the quadcopter in difficult conditions, the weather conditions may be monitored and best practices may be defined and implemented.

In some embodiments, the quadcopter may be capable of minimizing health risks via performing minimal flying in zones or regions where people or animals are present thereby facilitating avoidance of accidents, injuries or damages upon sudden altitude drops. In some embodiments, the quadcopter may comprise at least one of manually and automatically controllable settings thereof for flying with GPS assistance, thereby ensuring default or required settings are in place. For instance, in the event of signal loss occurring on the ground between the controls and the quadcopter, the quadcopter may fly back to the original take off location unassisted.

In some preferred embodiments, the active RFID tags may be capable of operating in the UHF spectrum with the readers at a given operating frequency, for instance 433 MHz, thereby ensuring a dynamic and an adjustable receiver sensitivity ranging from a minimum of approximately <50 dB to a maximum of approximately 108 dB. In use, the active RFID Tags may be read at a given rate, for instance approximately 100 tags per second and the tags may be grouped so that only a specific signal range is picked up, if required.

In some preferred embodiments, the total weight of any and all payloads on the quadcopter may be maintained at a minimum potential value, thereby facilitating maximization of flying time and performance. For example, and in no way limiting the scope of the invention, the RFID reader may have a mass of approximately 147 g. Further, the active RFID tags may be IP67 specification compliant, thereby ensuring that the active RFID tags are rugged tags, which may be capable of operating in difficult environmental conditions and may be less prone to failures. Still further, the read range for the active RFID tags may be up to a maximum of approximately 300 ft, and an operating temperature ranging from a minimum of approximately 20° C. to a maximum of approximately 70° C. In addition, the active RFID tags may have a low battery feature thereby ensuring pick up of the active RFID tags that may be coming to the end of the lifespan therefor, for instance typical battery life based on a 2-second beacon is about four years.

Furthermore, the PDA mounted as a payload on the quadcopter may also be as light and rugged as possible. Likewise, the RFID reader mounted also as a payload on the quadcopter may be light, for instance 260 g, with a reliable battery source and the operating temperatures similar to active RFID tags. In use, the PDA may host the TRACK'EM® LIVE SOFTWARE, which may be capable of working in offline mode. In some scenarios involving design and implementation of best practices in connection with the deployment of the quadcopter, it is recommended to ensure that the PDA of the quadcopter is synchronized before mounting and synchronized after flight so as to make sure the latest data is available on the PDA.

In some embodiments, the quadcopter may be customised, in accordance with the principles of the present invention. For instance, the quadcopter may be designed and realized to possess a standard chassis for both the PDA and the RFID reader. Further, the quadcopter may be optimized to increase stability and ensure redundant increase in overall thereby facilitating increase in flying time. For instance, with multiple design and implementation options at disposal in accord with the principles of the present invention, the primary objectives are accomplishment of a flight time of a minimum of approximately thirty minutes, made-to-measure chassis to dock the RFID reader, PDA and protectors therefor to minimize damage to the quadcopter at times of emergency.

Reiterating, in some operational embodiments involving assets management, one or more of the active RFID tags may be embedded on one or more assets by at least one of off-site suppliers upon delivery and on-site end users upon arrival. Specifically, the serial numbers associated with the active RFID tags may be recorded and stored in a given Enterprise Resource Planning (ERP®) system. Upon completion of recording and storage of the serial numbers, the recorded serial numbers may be assigned to the assets with corresponding active RFID tags embedded thereon. The UAV (or quadcopter) may comprise the active RFID reader and the PDA as payloads. In use, the PDA may be capable of running mobile application software for material tracking and management. For example, and in no way limiting the scope of the invention, the mobile application software for material tracking and management may be TRACK'EM® LIVE SOFTWARE. The TRACK'EM® LIVE SOFTWARE is a system that integrates the barcode, RFID and GPS technologies to improve project management on construction sites.

In some embodiments, the TRACK'EM® LIVE SOFTWARE system may facilitate fast tracking, locating and monitoring of tagged materials or assets onsite. In some embodiments, the TRACK'EM® LIVE SOFTWARE system may comprise 1) a central database, for instance a database server that implements at least one of Structured Query Language (SQL) and .NET Framework to store material information; 2) a portable computing and communications device, for instance a PDA, smartphone, may be enabled with Symbol® barcode scanners for capture of barcode or RFID information; 3) a GPS receiver to record GPS coordinates; 4) a drawing register or document control for onsite access; 5) one or more Rules-of-Credits (RoCs) for progress and planning control; and 6) a 3D modeling plug-in for linking 3D models with TRACK'EM® LIVE SOFTWARE may be enabled with AUTODESK®'S Navisworks 3D thereby providing a complete visual status the entire project.

For instance, the drawing register may comprise at least one of date and time of receipt, drawing number, revision number, drawing title, purposes of issue, such as for construction, for information or for tender, an accompany document reference, such as Site Instruction (SI), Drawing Amendment Notification (DAN), Variation Order (VO), transmittal, correspondence, and the like.

In use, the TRACK'EM® LIVE SOFTWARE may record and store the data as picked up by the active RFID Reader during flight. Like the quadcopter, both the active RFID reader and PDA may have a battery source.

In use, the operator of the quadcopter may at least one of key in the desired GPS coordinates for the quadcopter to fly for creating a flight path and manually control the quadcopter to pilot as per need.

In use, the quadcopter may fly over the lay down yard or open space and picks up RF signals captured by the active RFID reader. The RFID reader may facilitate wireless transmission of the captured information via BLUETOOTH® to the PDA for subsequent storage in the TRACK'EM® LIVE SOFTWARE.

In use, upon landing at the home base or ground station, the PDA of the quadcopter UAV may be dismounted and synchronized over an Internet connection to a main ERP database.

In some embodiments, the quadcopter, PDA and active RFID reader may be recharged to restore power or charge to corresponding batteries therefor.

In some scenarios, multiple assets or materials may be spread across a large area. The assets or materials may have been left in the large area for purposes of storage and maintenance. Each of the assets or materials may comprise of an Ultra High Frequency (or Ultra Wide Band) Radio Frequency Identification (RFID) tag embedded thereupon. For example, each of the assets or materials may comprise of an active UHF or UWB RFID tag. The UHF or UWB RFID tags may be capable of facilitating identification or detection and tracking of the materials or assets.

In use, a RFID reader-equipped Unmanned Aerial Vehicle (UAV) (or quadcopter) may be deployed for identification or detection and tracking of the materials or assets. Specifically, the RFID reader-equipped UAV may comprise a long range RFID reader.

In operation, the RFID reader-equipped UAV may be capable of picking up or capturing the Radio Frequency (RF) signals from the tags embedded upon the materials or assets on the ground. For example, the active UHF or UWB RFID tags may be capable of transmitting RF signals intermittently in a period of approximately two seconds. Upon returning to a base or control centre, the RFID reader may be synchronized with a database thereby facilitating synchronization of the information captured by the RFID reader with the database.

In some embodiments, the RFID reader equipped UAV may be at least one of operated by a human pilot, autopilot and remotely controlled from the base.

In some embodiments, the GPS coordinates of one or more locations to be traversed by the RFID reader equipped UAV in a given region are plotted on a portable computing and communications device. Upon initiation of proprietary application software implemented (or running) on the portable computing and communications device, the RFID reader equipped UAV starts flying and aerially traversing each of the one or more locations in the given region based on the GPS coordinates.

Upon returning to the base or control centre, the RFID reader may be synchronized with the database thereby facilitating synchronization of the information captured by the RFID reader with the database. For example, the RFID reader may be synchronized with the database using a wireless network, for instance a Wi-Fi network.

In some embodiments, the assets may be stored in at least one of lay down yard, warehouse and similar material handling storage location. In operation, in the event that one or more assets installed fall in a given geo-fence at a work front facilitates indicates of the final installation location of the assets.

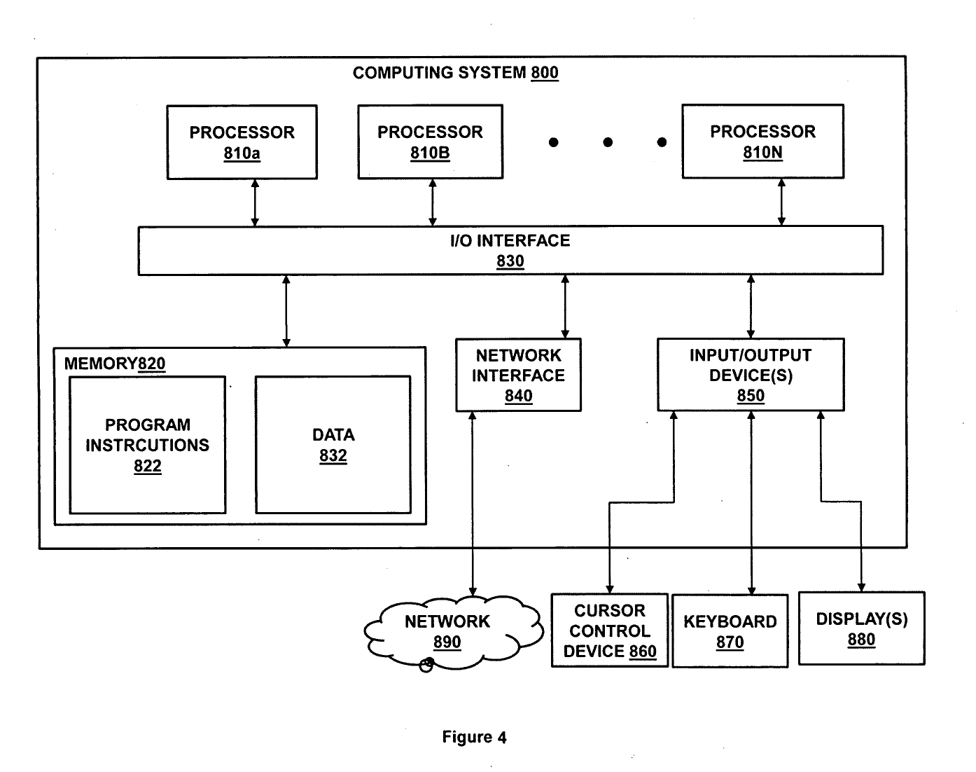

FIG. 4 depicts a computer system that is a computing device and can be utilized in various embodiments of the present invention, according to one or more embodiments.

Various embodiments of method and system for assets management using integrated Unmanned Aerial Vehicle (UAV) and Radio Frequency Identification (RFID) reader, as described herein, may be executed on one or more computer systems, which may interact with various other devices. One such computer system is computer system 800 illustrated by FIG. 6, which may in various embodiments implement any of the elements or functionality illustrated in FIGS. 1-5A-J. In various embodiments, computer system 800 may be configured to implement one or more methods described above. The computer system 800 may be used to implement any other system, device, element, functionality or method of the above-described embodiments. In the illustrated embodiments, computer system 800 may be configured to implement one or more methods as processor-executable executable program instructions 822 (e.g., program instructions executable by processor(s) 810A-N) in various embodiments.

In the illustrated embodiment, computer system 800 includes one or more processors 810A-N coupled to a system memory 820 via an input/output (I/O) interface 830. The computer system 800 further includes a network interface 840 coupled to I/O interface 830, and one or more input/output devices 850, such as cursor control device 860, keyboard 870, and display(s) 880. In various embodiments, any of components may be utilized by the system to receive user input described above. In various embodiments, a user interface (e.g., user interface) may be generated and displayed on display 880. In some cases, it is contemplated that embodiments may be implemented using a single instance of computer system 800, while in other embodiments multiple such systems, or multiple nodes making up computer system 800, may be configured to host different portions or instances of various embodiments. For example, in one embodiment some elements may be implemented via one or more nodes of computer system 800 that are distinct from those nodes implementing other elements. In another example, multiple nodes may implement computer system 800 in a distributed manner.

In different embodiments, computer system 800 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 800 may be a uniprocessor system including one processor 810, or a multiprocessor system including several processors 810 (e.g., two, four, eight, or another suitable number). Processors 810A-N may be any suitable processor capable of executing instructions. For example, in various embodiments processors 810 may be general-purpose or embedded processors implementing any of a variety of instruction set architectures (ISAs), such as the x96, POWERPC®, SPARC®, or MIPS® ISAs, or any other suitable ISA. In multiprocessor systems, each of processors 810A-N may commonly, but not necessarily, implement the same ISA.

System memory 820 may be configured to store program instructions 822 and/or data 832 accessible by processor 810. In various embodiments, system memory 820 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 820. In other embodiments, program instructions and/or data may be received, sent or stored upon different types of computer-accessible media or on similar media separate from system memory 820 or computer system 800.

In one embodiment, I/O interface 830 may be configured to coordinate I/O traffic between processor 810, system memory 820, and any peripheral devices in the device, including network interface 840 or other peripheral interfaces, such as input/output devices 850. In some embodiments, I/O interface 830 may perform any necessary protocol, timing or other data transformations to convert data signals from one components (e.g., system memory 820) into a format suitable for use by another component (e.g., processor 810). In some embodiments, I/O interface 830 may include support for devices attached through various types of peripheral buses, such as a variant of the Peripheral Component Interconnect (PCI) bus standard or the Universal Serial Bus (USB) standard, for example. In some embodiments, the function of I/O interface 830 may be split into two or more separate components, such as a north bridge and a south bridge, for example. Also, in some embodiments some or all of the functionality of I/O interface 830, such as an interface to system memory 820, may be incorporated directly into processor 810.

Network interface 840 may be configured to allow data to be exchanged between computer system 800 and other devices attached to a network (e.g., network 890), such as one or more external systems or between nodes of computer system 800. In various embodiments, network 890 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 840 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 850 may, in some embodiments, include one or more display terminals, keyboards, keypads, touchpads, scanning devices, voice or optical recognition devices, or any other devices suitable for entering or accessing data by one or more computer systems 800. Multiple input/output devices 850 may be present in computer system 800 or may be distributed on various nodes of computer system 800. In some embodiments, similar input/output devices may be separate from computer system 800 and may interact with one or more nodes of computer system 600 through a wired or wireless connection, such as over network interface 640.

Those skilled in the art will appreciate that computer system 800 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 800 may also be connected to other devices that are not illustrated or, instead, may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments, some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 800 may be transmitted to computer system 800 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A system for managing assets, said system comprising:
at least one RFID tag coupled to at least one asset;
an unmanned aerial vehicle including
a radio frequency identification device reader for at least one of reading, writing, and combined writing/reading RFID signals from, and to, said at least one RFID tag;
a portable computing and communications device for facilitating transmission, reception, processing, and storage of data;
one or more sensors for capturing images and data;
a ground management subsystem including a host computing unit with an enterprise resource planning module; and
a network subsystem.

2. The system of claim 1, wherein the assets comprise at least one of people, materials, tools, and equipment.

3. The system of claim 1, wherein the UAV facilitates at least one of quality control and maintenance as part of material control via capturing at least one of videos and images of the assets using said one or more sensors.

4. The system of claim 1, wherein said at least one RFID tag comprises one or more of an active RFID tag, a passive RFID tag, a batter-assisted passive RFID tag, and a hybrid RFID tag.
